(19) United States
(12) Patent Application Publication
(10) Pub. No.: US 2010/0200314 A1
(43) Pub. Date: Aug. 12, 2010

(54) ENERGY STORAGE ASSEMBLY WITH POKA-YOKE CONNECTIONS

(76) Inventors: Peter Birke, Glienicke/Nordbahn (DE); Swen Wiethoff, Berlin (DE); Michael Keller, Baden Baden (DE); Frank Czogalla, Berlin (DE); Kazuhiro Takahashi, Yamagata-Prefecture (JP); Hideo Yabe, Saitama-Prefecture (JP); Kiyoko Abe, Yamagata-Prefecture (JP); Kazunori Ozawa, Miyagi-Prefecture (JP)

Correspondence Address: RATNERPRESTIA, P.O. BOX 980, VALLEY FORGE, PA, 19482, US

(21) Appl. No.: 12/597,297

(22) PCT Filed: Apr. 23, 2008
(86) PCT No.: PCT/EP08/03262

§ 371 Date: Apr. 16, 2010

(30) Foreign Application Priority Data
Apr. 24, 2007 (DE) 10 2007 019 625.5

(51) Int. Cl. B60K 6/28; H01M 2/26; H01M 6/46

(52) U.S. Cl. 180/65.21; 429/158; 903/907

(57) ABSTRACT

An energy storage assembly with a plurality of flat electrochemical cells, each of them includes a pair of electrodes which electrically connect the electrochemical cells with each other through outward electrode terminals, wherein each electrochemical cell includes as a pair of outward electrode terminals a straight outward terminal and a curved outward terminal, the electrochemical cells are connected with each other that a straight outward terminal of one of the electrochemical cell is connected with a curved outward terminal of an adjacent electrochemical cell.

### CROSS REFERENCE TO RELATED APPLICATIONS

This application is the U.S. national phase application of PCT/EP2008/003262, filed Apr. 23, 2008, which claims priority from German application serial No. 10 2007 019 625.5, filed on Apr. 24, 2007, the content of such applications being incorporated by reference herein.

### FIELD OF THE INVENTION

The present invention relates to an energy storage assembly and an electric car or a hybrid type electric car using the same. The energy storage assembly (also called battery pack) comprises a plurality of flat electrochemical cells (also called battery cells) each of them comprises a pair of electrodes which electrically connect the electrochemical cells with each other through outward terminals.

### BACKGROUND OF THE INVENTION

In order to satisfy requirements such as higher input-output power sources for applications, e.g. electric cars, hybrid cars, electric tools, etc. new energy storage assemblies, e.g. lead-acid batteries, lithium-ion batteries, nickel metal hydride batteries, nickel-cadmium batteries and electric double layer capacitors, etc. have been developed.

These new energy storage assemblies power the electric driving motor and the vehicle on-board electrical system. To control the charge-discharge procedures of the energy storage assembly a controller is integrated which manages the charge-discharge procedures, the conversion from braking energy into electric energy (=renewable braking), etc, so that the energy storage assembly can charge during vehicle operation.

The energy storage assembly or each single electrochemical cell should exhibit good characteristics such as a maximum voltage range of 100 V to 450 V with current of 400 A and for extreme condition, e.g. high temperature, with current up to 500 A. Continuous current is in the range of 80 A to 100 A or even also higher depending on the application.

For such extreme conditions the connection of the electrochemical cells of energy storage assembly is extremely stressed.

Normally, the connections are provided through crimps, screws or weld points. Often, the electrochemical cells are damaged during setting up the connection through thermal and mechanical stress.

Accordingly, an object of the invention is to provide an energy storage assembly whose connections shall exhibit a high reliability, e.g. up to 15 years, under extreme conditions, e.g. in a vehicle under high vibration and high temperature. Furthermore the energy storage assembly shall exhibit a good ampacity (i.e. a good current carrying capacity, whereas the connection resistance should be smaller than the internal cell resistance) and high capacity against thermal and mechanical stress.

### SUMMARY OF THE INVENTION

In order to satisfy this object, an energy storage assembly is provided with fail-safe connections of the electrochemical cells through so called poka-yoke (=a fail-safe contact in such a way that contact elements are designed that they do not misconnect with each other).

In accordance with an aspect of the invention, the energy storage assembly comprises a plurality of flat electrochemical cells, each of them comprises a pair of electrodes which electrically connect the electrochemical cells with each other through outward electrode terminals, wherein each electrochemical cell comprises as a pair of outward electrode terminals a straight outward terminal and a curved outward terminal and wherein the electrochemical cells are connected with each other that a straight outward terminal of one of the electrochemical cell is connected with a curved outward terminal of an adjacent electrochemical cell.

Such design of the outward terminals allows that the electrochemical cells do not misconnect. Furthermore, this design allows an effective, space-saving arrangement of the electrochemical cells in a pack, e.g. in a battery or energy storage pack, in which the flat electrochemical cells are stacked on top of each other. Such a stack arrangement allows a simple and effective division of the stack into modules of a number of cells.

For a fixed, permanent, reliable connection with a high ampacity each outward terminal comprises at least one bulge. Preferably, each outward terminal comprises at least two bulges, which are horizontally separated by a vertical slot (cavity) in the outward terminal. In a possible embodiment, each outward terminal is outwardly slotted in two tags. Preferably, one bulge is arranged on each tag of an outward terminal. Such double arrangement of two bulges on one outward terminal, especially on each tag of an outwardly slotted outward terminal allows a simple redundant connection of the outward terminals of two electrochemical cells which connect with each other. The slot in each outward terminal and the bulge on each tag allow an effective current concentration during resistance welding, whereby the welding is performed efficiently and with preferably low thermal stress for the electrochemical cell through high concentration of the welding current on the bulge, e.g. welding bulge, on each tag. Furthermore, the outward slot separates the at least two welding connections so that mechanical stresses in one of the connections have no influence on the other connection.

Alternatively, the outward terminals are not slotted and do not comprise bulges if the outward terminals are connected by ultrasonic welding.

In a further embodiment of the invention, the outward terminals of each electrochemical cell are arranged on opposite ends of one cell side of their electrochemical cell. Such an arrangement of the outward terminals on one cell side, e.g. on the upper side of the cell, and on opposite ends of this side allows a simple and effective external connection of the outward terminals with additional bus bars and an effective and space-saving and also a very good symmetric structure of the battery pack with a simple connection of the outward terminals. Furthermore, the slotted outward terminal allows a simple connection of external connected elements, such as crimp elements and clip elements of cables, etc., e.g. by a lithium-ion battery application for cell balancing. In an alternative embodiment of the invention, the outward terminals of each electrochemical cell are arranged on one end of one cell side of their electrochemical cell.

In accordance with a further aspect of the invention, each outward terminal has a thickness of at least 1 mm. The thickness can vary based on particular applications, e.g. of the size of the energy storage assembly, especially of the size of the single electrochemical cell. The larger the assembly or cell is the larger is the thickness of the outward terminal. For example, the thickness should be in the range of about 1 mm to about 3 mm. This allows that an additional active electrode surface is given by the same cell outer surface because the required terminal section is provided by the new terminal thickness. Furthermore, such terminal thickness allows a reduction of the transition surface between inner cell and outer cell, whereby the tightness in this transition surface is increased.

In a possible embodiment of the invention, each outward terminal is composed of at least copper. In a further possible embodiment, each outward terminal is composed of at least copper coated with a protection layer. The protection layer is composed of e.g. stannous or nickel or an alloy, e.g. an alloy of aluminum manganese or aluminum copper.

Additionally, the outward terminals can be covered by fastening elements, such as clip elements, especially plastic clip elements. Such clip elements arrangement on each terminal allows a simple protection against corrosion and isolation. In a possible embodiment the clip element is an L-profile.

Furthermore, the outward terminals of each electrochemical cell are connected with the inner part of their electrochemical cell through coupling elements. Preferably, the coupling elements are rivets, crimps, screws or in the inner part integrated weld points, which are welded, e.g. through ultrasonic welding.

In a further embodiment of the invention, a predetermined number of electrochemical cells are arranged in at least two or modules or groups. Preferably, two modules or groups of a number of cells are separated by a protection element, especially by a fuse element, e.g. a short-circuit fuse.

Depending on the application the electrochemical cells are connected in series, parallel or in parallel-series.

The invention can be used in electric cars, in hybrid electric vehicles, especially in parallel hybrid electric vehicles, serial hybrid electric vehicles or parallel/serial hybrid electric vehicles.

The present invention is now further described with particular reference to the following embodiments in the drawing. However, it should be understood that these embodiments are only examples of the many advantageous uses of the innovative teachings herein.

### BRIEF DESCRIPTION OF THE DRAWINGS

FIG. 1 shows a view of an energy storage assembly with a plurality of electrochemical cells which are connected with each other through pairs of outward terminals of each cell,

FIG. 2 shows a view of one of the electrochemical cell,

FIG. 3 shows a view of an electrochemical cell which is adjacent to the electrochemical cell according to FIG. 2,

FIG. 4 shows a view of an energy storage assembly with a plurality of electrochemical cells which are grouped into two or more modules without a cell-block or cell-module rotation, and

FIG. 5, 6 each of them show a view of another energy storage assembly with a plurality of electrochemical cells which are grouped into two or more modules with a cell-block or cell-module rotation.

### DETAILED DESCRIPTION OF THE DRAWINGS

The present invention relates to an energy storage assembly. The present invention can be used in different application, e.g. in a hybrid electric vehicle, whereby the hybrid electric vehicle having a driving motor and an internal combustion engine, wherein the driving motor is driven by power supplied from the energy storage assembly. Alternatively, the energy storage assembly can also be used in an electric car having a driving motor driven by power supplied from the energy storage assembly. Furthermore the present invention can be used for storing energy, e.g. wind or solar energy, for which the energy storage assembly is integrated in a wind or solar energy plant. The invention can be also used for load leveling applications.

FIG. 1 shows a view of an energy storage assembly 1 with a plurality of flat electrochemical cells 2. The assembly 1 is often called battery pack. Each electrochemical 2 is also called battery cell or single galvanic cell or prismatic cell.

Each of the electrochemical cells 2 comprises a pair of electrodes A and K, whereby one of the electrodes A is an anode or negative electrode and the other electrode K is a cathode or positive electrode.

To electrically connect the electrochemical cells 2 with each other the electrodes A and K of each cell 2 are connected with outward terminals 3.A and 3.K. Depending on the application the electrochemical cells 2 can be connected through the outward terminals 3.A and 3.K in parallel, in series or in parallel-series.

The shown embodiment according to FIG. 1 presents electrochemical cells 2 which are connected in series.

For fail-safe installation and assembling, especially a fail-safe connection of the electrochemical cells 2 with each other, the pair of outward terminals 3.A and 3.K of each cells 2 are differently designed in that one of the outward terminals, e.g. the outward anode terminal 3.A, has a straight form; the other outward terminal of the same cell 2, e.g. the outward cathode terminal 3.K, has a curved form or vice versa. Furthermore, the outward terminals 3.A and 3.K of adjacent electrochemical cells 2, which are connected with each other, are also differently designed in that one of the connected outward terminals, e.g. the outward anode terminal 3.A, of one of the electrochemical cells 2 has a straight form; if these cells 2 are parallel connected with each other the outward anode terminal 3.A of the adjacent electrochemical cell 2 has a curved form; if these cells 2 are connected in series with each other the outward cathode terminal 3.K of the adjacent electrochemical cell 2 has a curved form.

With other words: For a space-saving and fail-safe installation and assembling of the whole energy storage assembly 1 the electrochemical cells 2 are connected with each other that a straight outward terminal 3.A or 3.K of one of the electrochemical cells 2 is connected with a curved outward terminal 3.A or 3.K of an adjacent electrochemical cell 2 depending on the kind of connection, e.g. in parallel, in series or in parallel-series.

Each electrochemical cell 2 is a flat cell, which comprises e.g. as electrodes A and K a plurality of not shown inner electrode film, whereby different electrode films separated by a not shown separator film rinsed with an e.g. non-aqueous electrolyte. Alternatively, plates can be used instead of films. Depending on the kind of cell 2, e.g. a lithium-ion cell; the electrode films are divided in two different groups of films. One group of the electrode films represents the cathode or positive electrode K, e.g. of a lithium-transition metal oxide, the other group of the electrode films represents the anode or negative electrode A, e.g. of metallic lithium or lithium graphite.

More specifically, the outward terminals 3.A, 3.K of each electrochemical cell 2 are connected with the inner part of their electrochemical cell 2, especially with the respective electrodes A, K through not shown coupling elements. The coupling elements can be provided as rivets, crimps, bolts or weld points.

Furthermore, the arrangement of electrode films with separator films is surrounded by a casing 4. The casing 4 can be provided as a film casing or a plate casing which isolates the cells 2 of each other. Preferably, the cells 2 are at least electrically isolated of each other. Additionally, the cells 2 can be thermally isolated of each other depending on the used material. Alternatively, the cells 2 can be electrically connected through the casing surface. Another alternative embodiment can be provided in that a material, e.g. a resin, is filled between the cells 2 for electrical isolation.

Depending on the kind and size of the energy storage assembly 1 the outward terminals 3.A, 3.K of each electrochemical cell 2 are arranged on opposite ends of one cell side 2.1 of their electrochemical cell 2. Alternatively, the outward terminals 3.A, 3.K of each electrochemical cell 2 can be arranged on one end of the cell side 2.1 (not shown).

For a simple installation of the energy storage assembly 1 with the plurality of cells 2 (also called battery pack or package) the cells 2 are fixed on a bottom plate 5 by form or friction fitting of each cell 2 in the plate 5.

The whole energy storage assembly 1 can also be surrounded by a not shown casing.

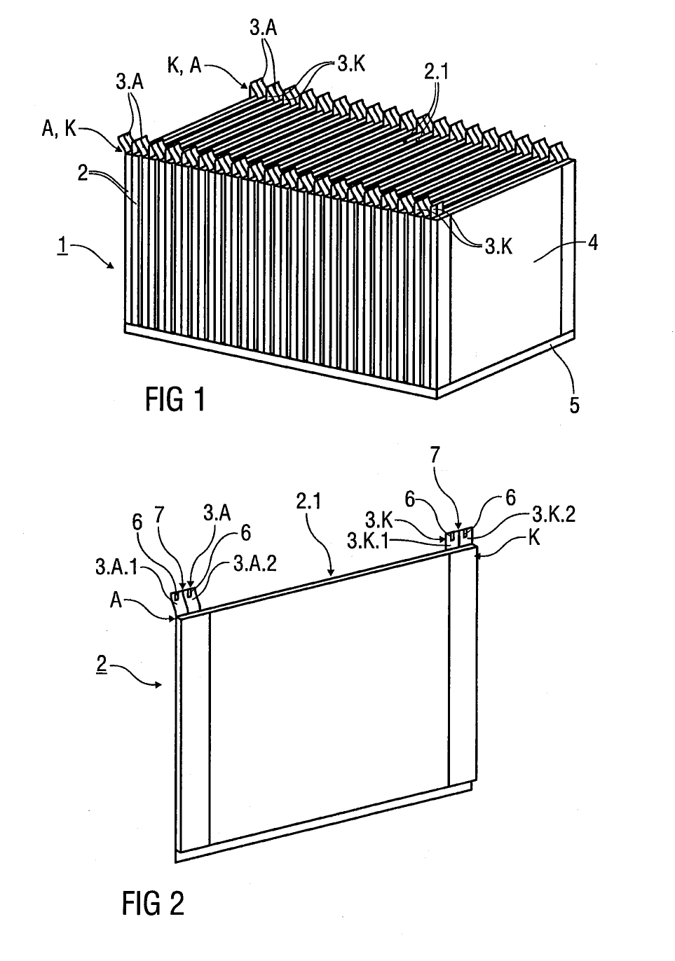

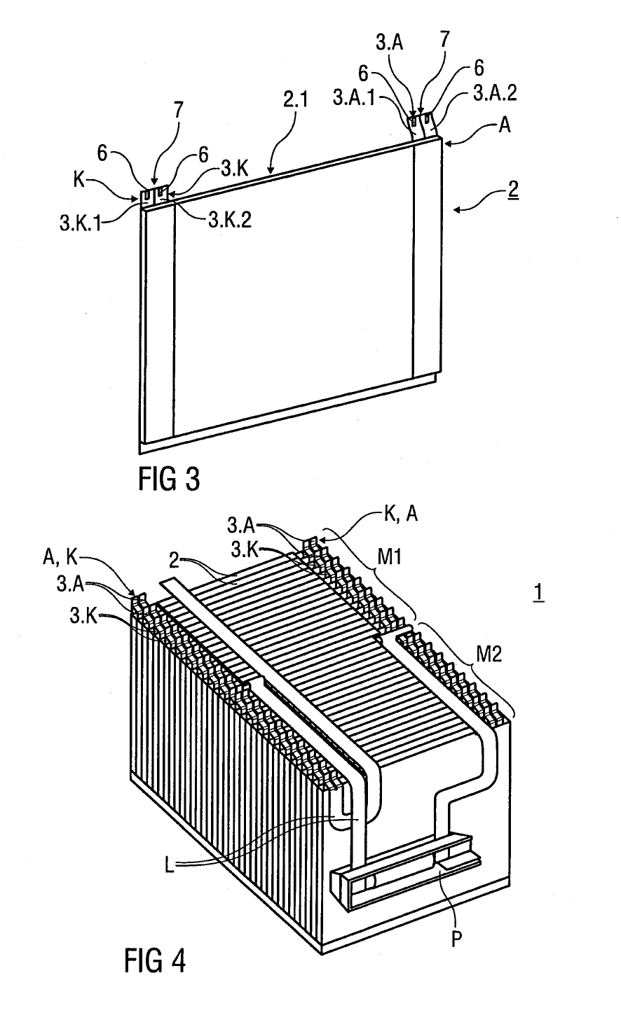

Regarding FIGS. 2 and 3 each of them shows a single electrochemical cell 2, which are adjacent in the energy storage assembly 1 according to FIG. 1 and which are to be connected with each other in series.

For a strong connection of the relevant outward terminals 3.A and 3.A, 3.K and 3.K to be connected, one of the outward terminals 3.K or each outward terminal 3.A and 3.K comprises at least one bulge 6. In the described embodiment according to FIGS. 2 and 3 each outward terminal 3.K of the cells 2 comprises two bulges 6.

To reduce mechanical stresses during welding of the outward terminals 3.A and 3.K, 3.K and 3.A to be connected, each outward terminal 3.A and 3.K is horizontally separated by a vertical slot 7 or cavity, so that each outward terminal 3.A, 3.K is outwardly slotted in two tags 3.A.1 and 3.A.2 or 3.K.1 and 3.K.2. Such slot 7 allows that two bulges 6, wherein one bulge 6 is arranged on each tag 3.A.1, 3.A.2, 3.K.1, 3.K.2 of one outward terminal 3.A, 3.K, are provided for a redundant connection of outward terminals 3.A, 3.K of adjacent cells 2. Furthermore, the outward slot 7 allows at least two welding connections with reduced mechanical stresses.

An additional advantage of the slot 7 is that a slotted outward terminal 3.A, 3.K allows to directly connect e.g. balancing cables, electric components and other devices to the terminal 3.A, 3.K, especially to the tags 3.A.1, 3.A.2, 3.K.1, 3.K.2.

Alternatively, sensor elements, such as temperature sensor elements, can be directly integrated in the outward terminal 3.A, 3.K. This allows a very efficient temperature measurement.

Especially, depending on the size of the energy storage assembly 1 the thickness of each outward terminal 3.A, 3.K can be varied in a range of 1 mm to 3 mm. In one embodiment, each outward terminal 3.A, 3.K can have a thickness of at least 1 mm. Alternatively, the outward terminals 3.A, 3.K can have a different thickness in the above mentioned range depending on the available space and required compactness and tightness.

Furthermore, the outward terminals 3.A, 3.K can be formed differently in that the current distribution from the respective cell 2 is efficiently performed. For instance, the connecting end of each outward terminal 3.A, 3.K can have a cone form. The connecting end of each outward terminal 3.A, 3.K is the end through which the terminal 3.A, 3.K is connected with the respective inner electrode A, K.

Preferably, each outward terminal 3.A, 3.K is composed of at least copper. Each outward terminal 3.A, 3.K are composed of the same material. This allows the same welding temperature. Furthermore, each outward terminal 3.A, 3.K can be composed of at least copper coated with a protection layer. Preferably, the protection layer is composed of stannous or nickel against corrosion. The protection layer is very thin. For instance, the protection layer has a thickness of a few μm.

Furthermore, FIGS. 4 to 6 show further embodiments with grouped electrochemical cells 2.

FIG. 4 shows the assembly 1 (also called battery pack) without a cell-block or cell-module M1 to M2 rotation. These result in crossing of bus bars and big total length of bus bars.

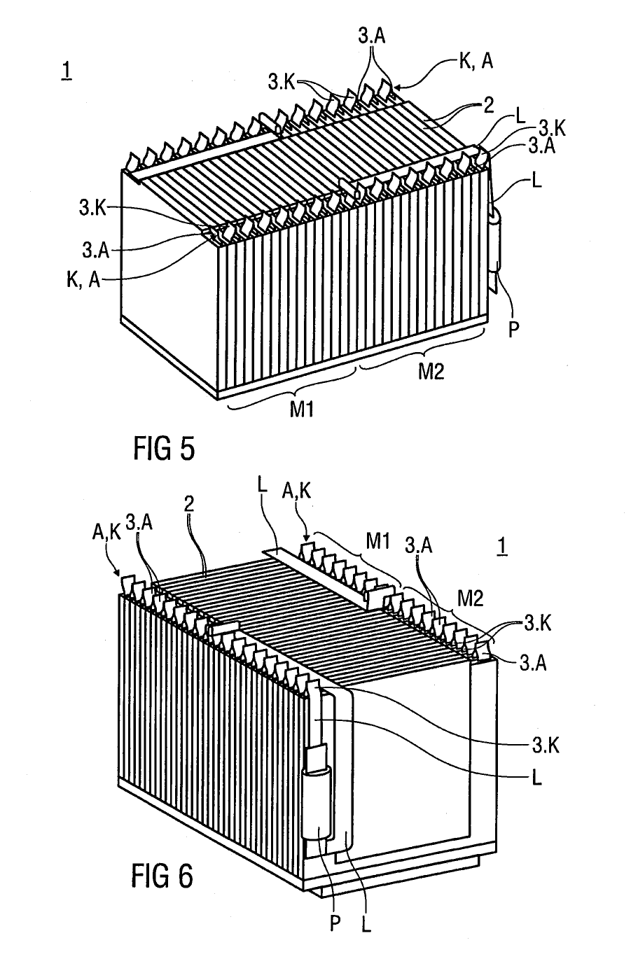

FIGS. 5 and 6 show the assembly with a cell-block or cell-module rotation of 180°. These result in mo crossing of bus bars. The total length reduction of bus bars.

Preferably, a predetermined number of electrochemical cells 2, e. g. 6 cells or 12 cells are arranged in at least two or more modules M1 to Mn or groups. For a simple short-circuit fuse of the cells 2, the modules M1 to M2 are separated by a protection element P, e.g a fuse, especially a short-circuit fuse.

Additionally, the outward terminals 3.A, 3.K can be covered by fastening elements, e.g. clip elements L, especially plastic clips or plastic L-profiles for protection and isolation.

1.-20. (canceled)

21. Energy storage assembly with a plurality of flat electrochemical cells, each of the flat electrochemical cells comprising a pair of electrodes which electrically connect the electrochemical cells with each other through outward terminals,
wherein each electrochemical cell comprises a pair of outward terminals, a straight outward terminal and a curved outward terminal,
wherein the electrochemical cells are connected with each other such that a straight outward terminal of one of the electrochemical cells is connected with a curved outward terminal of an adjacent electrochemical cell.

22. Energy storage assembly according to claim 21, wherein each outward terminal comprises at least one bulge.

23. Energy storage assembly according to claim 21, wherein each outward terminal comprises at least two bulges, which are horizontally separated by a vertical slot in the outward terminal.

24. Energy storage assembly according to claim 21, wherein each outward terminal is outwardly slotted in two tags.

25. Energy storage assembly according to claim 24, wherein one bulge is arranged on each tag of an outward terminal.

26. Energy storage assembly according to claim 21, wherein the outward terminals of each electrochemical cell are arranged on opposite ends of one cell side of their electrochemical cell.

27. Energy storage assembly according to claim 21, wherein the outward terminals of each electrochemical cell are arranged on one end of one cell side of their electrochemical cell.

28. Energy storage assembly according to claim 21, wherein each outward terminal has a thickness of at least 1 millimeter.

29. Energy storage assembly according to claim 21, wherein each outward terminal is composed of at least copper.

30. Energy storage assembly according to claim 21, wherein each outward terminal is composed of at least copper coated with a protection layer.

31. Energy storage assembly according to claim 30, wherein the protection layer is composed of stannous or nickel or an alloy.

32. Energy storage assembly according to claim 30, wherein the alloy is an alloy of aluminum manganese or aluminum copper.

33. Energy storage assembly according to claim 21, wherein the outward terminals of each electrochemical cell are connected with an inner part of their electrochemical cell through coupling elements.

34. Energy storage assembly according to claim 33, wherein the coupling elements are rivets, crimps, bolts or weld points integrated in the inner part of the cell.

35. Energy storage assembly according to claim 21, wherein a predetermined number of electrochemical cells are arranged in at least two or more modules.

36. Energy storage assembly according to claim 35, wherein the modules are separated by a protection element.

37. Energy storage assembly according to claim 21, wherein the electrochemical cells are connected in series.

38. Energy storage assembly according to claim 21, wherein the electrochemical cells are connected in parallel.

39. Energy storage assembly according to claim 21, wherein the electrochemical cells are connected in parallel-series.

40. An electric car having a driving motor driven by power supplied from the energy storage assembly according to claim 21.

41. A hybrid type electric car having a driving motor and an internal combustion engine, wherein the driving motor is driven by power supplied from the energy storage assembly according to claim 21.
